(19) United States
(12) Patent Application Publication
(10) Pub. No.: US 2024/0043659 A1
(43) Pub. Date: Feb. 8, 2024

(54) HEAT CONDUCTING COMPOSITION

(71) Applicant: Resonac Corporation, Tokyo (JP)

(72) Inventors: Hajime FUNAHASHI, Tokyo (JP); Hikaru SATOH, Tokyo (JP); Hajime YUKUTAKE, Tokyo (JP); Ikue KOBAYASHI, Tokyo (JP)

(73) Assignee: Resonac Corporation, Tokyo (JP)

(21) Appl. No.: 18/354,873

(22) Filed: Jul. 19, 2023

(30) Foreign Application Priority Data
Jul. 22, 2022 (JP) 2022-117039

(51) Int. Cl. C08K 9/08; C08K 9/02

(52) U.S. Cl. CPC C08K 9/08; C08K 9/02; C08K 2201/001; C08K 2201/006; C08K 2201/005; C08K 2201/014

(57) ABSTRACT

A heat conducting composition including:
a polymer component (A);
a surface-treated filler (B) obtained by surface-treating a filler with α-butyl-ω-(2-trimethoxysilylethyl)polydimethylsiloxane having a weight average molecular weight of 500 to 5,000, with the α-butyl-ω-(2-trimethoxysilylethyl)polydimethylsiloxane having an adhesion percentage to the filler of from 20.0 to 50.0% by mass; and
a silicon-containing oxide-coated nitride (C) having a nitride and a silicon-containing oxide coating that coats the nitride.

### FIELD OF THE INVENTION

The present invention relates to a heat conducting composition.

### BACKGROUND OF THE INVENTION

Semiconductors are essential for electronic devices and automobiles. These semiconductors can also be a cause of failures, such as when the components of the semiconductor malfunction as the temperature rises. Therefore, various heat dissipating materials are used as heat countermeasures. In recent years, with the increase in the performance of semiconductors, the heat generated by semiconductors is tending to increase more and more, and materials with high thermal conductivity are required to quickly transfer the heat out of the system. One way to increase the thermal conductivity of the heat dissipating material is to increase the filling amount of the filler, which is easy to do and has a very large effect. However, in order to increase the filling amount, it is necessary to take steps such as using an elastomer with as low a viscosity as possible or using a filler with a small specific surface area, but there is a hesitancy to do so due to reasons such as product lineup and price. Therefore, surface treatment of the filler is performed as a method for facilitating the filling of the filler. Typical surface treatment agents include silane coupling agents, which are used to improve filling properties and various physical properties. In particular, long-chain alkylsilanes are relatively good as silane coupling agents from the viewpoint of improving filling properties. However, even with long-chain alkylsilanes, there have been more cases where it is not possible to achieve a high enough filling amount in order to reach the target thermal conductivity.

Further, by increasing the number of carbon atoms in a hydrophobic group of the long-chain alkylsilane, compatibility with the elastomer tends to improve. Hydrophobic groups up to about 18 carbon atoms can be obtained, but when the number of carbon atoms increases, the alkoxy group becomes difficult to hydrolyze, which can lead to such problems that it becomes more difficult to prepare the solution for dispersing the filler, polymerization or polymer film formation of the silane coupling agent may be slow or may not occur, and a large amount of unreacted silane coupling agent may remain in the polymer system. In addition, the unreacted silane coupling agent volatilizes, causing problems such as contamination of the apparatus and deterioration of the heat resistance of the heat dissipating material.

In order to solve these problems, various methods have been proposed for the surface treatment of fillers.

For example, PTL 1 proposes a method of surface-treating a thermally conductive filler by an integral method using dimethylpolysiloxane in which an end of the molecular chain is blocked with a trialkoxysilyl group. PTL 2 proposes a surface-treatment method by an integral method using a dimethylpolysiloxane in which one molecular chain end is blocked with a trialkoxysilyl group and a dimethylpolysiloxane in which both molecular chain ends are blocked with trialkoxysilyl groups. Further, PTL 3 proposes a surface-treatment method by an integral method using dimethylpolysiloxane in which one molecular chain end is blocked with a dialkoxysilyl group. PTL 4 proposes a surface-treatment method by an integral method using dimethylpolysiloxane in which one molecular chain end is blocked with a trialkoxysilyl group.

### CITATION LIST

### Patent Literature

PTL 1: JP-A-2020-180200
PTL 2: JP-T-2021-502426
PTL 3: CN-B-112694757
PTL 4: U.S. Pat. No. 10,604,658

### SUMMARY OF THE INVENTION

### Technical Problem

In the method of PTL 1, dimethylpolysiloxane in which one end of the molecular chain is blocked with a trialkoxysilyl group is used as the surface treatment agent, so a filler surface-treated with such dimethylpolysiloxane has excellent compatibility with silicone. However, dimethylpolysiloxane having one end of the molecular chain blocked with a trialkoxysilyl group has poor reactivity, for instance hydrolysis is slow just like long-chain alkylsilanes, and so it is necessary to stir it at high temperature for a long time for using it in surface treatment of a filler in an integral blend method. In addition, it is surprisingly difficult to synthesize a dimethylpolysiloxane in which one end of the molecular chain is blocked with a trialkoxysilyl group, and such materials were only available to silicone rubber manufacturers or laboratories dealing with organosilicon chemistry. Moreover, since the dimethylpolysiloxane has a trialkoxy group, in a condensed silicone system the dimethylpolysiloxane behaves as a cross-linking agent, and there is a problem in that it is difficult to adjust the hardness of the composition.

In the method of PTL 2, dimethylpolysiloxane in which one or both ends of the molecular chain are blocked with a trialkoxysilyl group is used as the surface treatment agent. In the dimethylpolysiloxane, the trialkoxysilyl group at the end(s) of the molecular chain and the polysiloxane group on the molecular chain are not bonded directly, but are bonded via a hydrocarbon group. Such dimethylpolysiloxane is synthesized from a polysiloxane having a SiH group at one end and a silane coupling agent having a vinyl group in the presence of a platinum catalyst. Until several decades ago, polysiloxane having a SiH group at one end was also a material available only to silicone rubber manufacturers or laboratories dealing with organosilicon chemistry, but since it can now be purchased and is commercially available, it has become easier to synthesize such dimethylpolysiloxane. However, since such dimethylpolysiloxane has some bonds via hydrocarbon groups, it tends to degrade at high temperatures. Moreover, when synthesizing such dimethylpolysiloxane, there is a problem in that the purity of the polysiloxane having a SiH group at one end of the raw material is low.

In the method of PTL 3, dimethylpolysiloxane in which one end of the molecular chain is blocked with a dialkoxysilyl group is used as the surface treatment agent. In the dimethylpolysiloxane, the dialkoxysilyl group at the one end of the molecular chain and the polysiloxane group on the molecular chain are not bonded directly, but are bonded via a hydrocarbon group. The synthesis method of the dimethylpolysiloxane is the same as in PTL2. It is known that a dialkoxysilyl group is more easily hydrolyzed than a trialkoxysilyl group, but when the molecular weight of the dialkoxysilyl group is large, there is almost no difference from the hydrolyzability of the trialkoxysilyl group. Therefore, in order to surface-treat the filler by the integral blend method using the dimethylpolysiloxane, it is necessary to stir for a long time at a high temperature.

In the method of PTL 4, dimethylpolysiloxane having a plurality of trialkoxysilyl groups at one end of the molecular chain (including a trifunctional resin structure) is used as the surface treatment agent. Since such a dimethylpolysiloxane has a plurality of trialkoxysilyl groups, it is considered that the probability of bonding with the filler is higher, but when the molecular weight of the siloxane portion is large, there is almost no difference from the hydrolyzability of a single trialkoxysilyl group. Therefore, in order to surface-treat the filler by the integral blend method using the dimethylpolysiloxane, it is necessary to stir for a long time at a high temperature. Moreover, there is a problem in that it is difficult to synthesize the surface treatment agent itself.

The present invention has been made to solve the problems described above, and it is an object thereof to provide a heat conducting composition from which a cured product having a low viscosity, a high thermal conductivity, and appropriate hardness can be obtained even when a polymer component is highly filled with a filler.

### Solution to Problem

The present inventors have made intensive studies to solve the above-described problems and have found that the problems can be solved by the following invention.

That is, the present application relates to the following.
[1] A heat conducting composition including:
   a polymer component (A);
   a surface-treated filler (B) obtained by surface-treating a filler with α-butyl-ω-(2-trimethoxysilylethyl)polydimethylsiloxane having a weight average molecular weight of 500 to 5,000, with the α-butyl-ω-(2-trimethoxysilylethyl)polydimethylsiloxane having an adhesion percentage to the filler of from 20.0 to 50.0% by mass; and
   a silicon-containing oxide-coated nitride (C) having a nitride and a silicon-containing oxide coating that coats the nitride.
[2] The heat conducting composition according to the above [1], wherein the nitride is aluminum nitride.
[3] The heat conducting composition according the above [1] or [2], wherein the filler has a cumulative volume-based 50% particle size of from 0.1 to 30 μm, and the nitride has a cumulative volume-based 50% particle size of from 10 to 150 μm.
[4] The heat conducting composition according to any of the above [1] to [3], wherein the filler is at least one selected from the group consisting of a metal, silicon, a metal oxide, a nitride, and a composite oxide.
[5] The heat conducting composition according to any of the above [1] to [4], wherein the polymer component (A) is at least one selected from the group consisting of a thermosetting resin, an elastomer, and an oil.
[6] The heat conducting composition according to any of the above [1] to [5], wherein the polymer component (A) has a viscosity at 25° C. of from 30 to 4,000,000 mPa·s.
[7] The heat conducting composition according to any of the above [1] to [6], wherein the polymer component (A) has a content of from 1.0 to 15.0% by mass, the surface-treated filler (B) has a content of from 30.0 to 96.0% by mass, and the silicon-containing oxide-coated nitride (C) has a content of from 3.0 to 55.0% by mass based on the total amount of the heat conducting composition.
[8] A cured product of the heat conducting composition according to any of the above [1] to [7].
[9] The cured product of the heat conducting composition according to the above [8], wherein the cured product has a thermal conductivity of 3.0 W/m·K or more.

### Advantageous Effects of the Invention

According to the present invention, it is possible to provide a heat conducting composition from which a cured product having a low viscosity, a high thermal conductivity, and appropriate hardness can be obtained even when a polymer component is highly filled with a filler.

### DETAILED DESCRIPTION OF THE INVENTION

Hereinbelow, the present invention will be described in detail with reference to one embodiment.

### <Heat Conducting Composition>

A heat conducting composition of the present embodiment includes a polymer component (A), a surface-treated filler (B) obtained by surface-treating a filler with α-butyl-ω-(2-trimethoxysilylethyl)polydimethylsiloxane having a weight average molecular weight of 500 to 5,000, with the α-butyl-ω-(2-trimethoxysilylethyl)polydimethylsiloxane having an adhesion percentage to the filler of from 20.0 to 50.0% by mass, and a silicon-containing oxide-coated nitride (C) having a nitride and a silicon-containing oxide coating that coats the nitride.

By including the surface-treated filler (B) and the silicon-containing oxide-coated nitride (C), it is possible to obtain from the heat conducting composition of this embodiment a cured product having a low viscosity, a high thermal conductivity, and appropriate hardness even when the polymer component is highly filled with a filler.

Each component will now be described in detail below.

### [Polymer Component (A)]

The polymer component (A) used in this embodiment is not particularly limited, and examples thereof include thermosetting resins, thermoplastic resins, elastomers, and oils. These may be used alone or as a mixture of two or more types.

From the viewpoint of obtaining the effects of the present invention, the polymer component (A) is preferably at least one selected from the group consisting of a thermosetting resin, an elastomer, and an oil. Thermosetting resin means a material in a state before curing, and as used herein, is not limited to the heat curing type, and may include materials that cure at normal temperature.

Examples of the thermosetting resin include epoxy resins, phenol resins, unsaturated polyester resins, melamine resins, urea resins, polyimides, and polyurethane.

Examples of the thermoplastic resin include polyolefins such as polyethylene and polypropylene; polyesters, nylons, ABS resins, methacrylic resins, acrylic resins, polyphenylene sulfides, fluororesins, polysulfones, polyetherimides, polyethersulfones, polyetherketones, liquid crystal polyesters, thermoplastic polyimides, polylactic acids, and polycarbonates.

The thermosetting resin and the thermoplastic resin may be modified with silicone or a fluororesin. Specific examples of modified resins include silicone-modified acrylic resins and fluororesin-modified polyurethanes.

Examples of the elastomer include natural rubber, isoprene rubber, butadiene rubber, 1,2-polybutadiene, styrene-butadiene, chloroprene rubber, nitrile rubber, butyl rubber, ethylene-propylene rubber (EPM, EPDM), chlorosulfonated polyethylene, acrylic rubber, epichlorohydrin rubber, polysulfide rubber, silicone rubber, fluoro rubber, and polyurethane rubber.

Examples of the oil include low-molecular-weight poly-α-olefins, low-molecular-weight polybutenes, silicone oils, and fluorine oils.

These may be used alone or as a mixture of two or more types.

From the viewpoint of availability of a low-viscosity product, the polymer component (A) is preferably polyurethane, silicone rubber, or silicone oil, and more preferably silicone rubber. The silicone rubber may be an addition-type silicone rubber or a peroxide-type silicone rubber.

As the polymer component (A), it is preferable to use a component having a viscosity at 25° C. of from 30 to 4,000,000 mPa s, more preferably from 50 to 3,500,000 mPa s, and further preferably from 100 to 3,000,000 mPa·s. When the viscosity is 30 mPa·s or more, the thermal stability is excellent, and when the viscosity is 4,000,000 mPa·s or less, the viscosity of the heat conducting composition can be reduced.

The viscosity of the polymer component (A) at 25° C. can be measured using a rotary viscometer based on JIS Z8803:2011 “Methods for measuring the viscosity of liquids”, and specifically by the method described in the Examples.

The content of the polymer component (A) is from 1.0 to 15.0% by mass, preferably from 1.2 to 14.0% by mass, more preferably from 1.4 to 12.0% by mass, and further preferably from 1.5 to 10.0% by mass based on the total amount of the heat conducting composition of this embodiment. When the content of the polymer component is 1.0% by mass or more, thermal conductivity can be imparted, and when the content is 15.0% by mass or less, the viscosity of the composition and the hardness of the cured product can be appropriate.

### [Surface-Treated Filler (B)]

The surface-treated filler (B) used in this embodiment is obtained by surface-treating the surface of a filler with α-butyl-ω-(2-trimethoxysilylethyl)polydimethylsiloxane having a weight average molecular weight of 500 to 5,000. The adhesion percentage of the α-butyl-ω-(2-trimethoxysilylethyl)polydimethylsiloxane to the filler is from 20.0 to 50.0% by mass.

Examples of the filler include metals; silicon; oxides, nitrides, carbides, hydroxides, fluorides, and carbonates of a metal, silicon, or boron; and carbon.

Examples of the metal include silver, gold, copper, iron, tungsten, stainless steel, aluminum, and carbonyl iron. It is preferable to use a metal that is easy to handle in the air.

Examples of the oxide include zinc oxide, aluminum oxide, magnesium oxide, silicon oxide, titanium oxide, iron oxide, calcium oxide, and cerium oxide. Composite oxides can also be used. In particular, the silicon oxide may be a natural product or a synthetic product. Specific examples include smokeless silica, wet silica, dry silica, fused silica, quartz powder, silica sand, silica stone, and silicic anhydride. Examples of the composite oxide include spinel, perovskite, barium titanate, laurel, and ferrite.

Examples of the nitride include aluminum nitride, boron nitride, and silicon nitride.

Examples of the carbide include silicon carbide, and boron carbide.

Examples of the hydroxide include aluminum hydroxide, magnesium hydroxide, iron hydroxide, cerium hydroxide, and copper hydroxide.

Examples of the fluoride include magnesium fluoride, and calcium fluoride.

Examples of the carbonate include magnesium carbonate, and calcium carbonate, and carbonate complex salts such as dolomite can also be used.

Examples of the carbon include graphite, and carbon black.

These can be used alone or as a mixture of two or more types.

From the viewpoint of various particle sizes, various shapes, price, and availability, the filler is preferably at least one selected from the group consisting of a metal, silicon, a metal oxide, a nitride, and a composite oxide, and more preferably is a metal oxide.

Considering the balance between thermal conductivity and cost, aluminum oxide (alumina) is preferable, and α-alumina is particularly preferable because of its high thermal conductivity. From the viewpoint of high thermal conductivity, aluminum nitride and boron nitride are preferably used, and from the viewpoint of low cost, silica, quartz powder, and aluminum hydroxide are preferably used.

From the viewpoint of imparting thermal conductivity, the thermal conductivity of the filler is preferably 0.5 W/m·K or more, and more preferably 1.0 W/m·K or more.

The shape of the filler is not particularly limited as long as it is a particle, and examples thereof include a spherical shape, a ball shape, a rounded shape, a scaly shape, a broken angular shape, and a fiber shape. A combination of such shapes may also be used.

The filler has a cumulative volume-based 50% particle size of preferably 0.1 to 30 μm, more preferably 0.2 to 28 μm, further preferably 0.3 to 25 μm, and still further preferably 0.3 to 20 μm, from the viewpoint of high filling properties into the polymer component (A).

The “cumulative volume-based 50% particle size” (hereinafter sometimes referred to as “D50”) herein can be determined from the particle size at which the cumulative volume is 50% in a particle size distribution measured using a laser diffraction particle size distribution analyzer.

The filler preferably has a specific surface area as determined by the BET method of from 0.05 to 10.0 m²/g, more preferably from 0.08 to 9.0 m²/g, and further preferably from 0.10 to 8.0 m²/g. When the specific surface area is within this range, the polymer component (A) can be highly filled, and the thermal conductivity of the cured product can be increased.

The specific surface area of the filler can be measured by the BET single-point method based on nitrogen adsorption using a specific surface area measurement apparatus, and specifically by the method described in the Examples.

The filler may be subjected in advance to other surface treatments such as a water-resistance treatment and fluidity improvement. Surface treatments such as a water-resistance treatment and fluidity improvement may be applied to the entire surface of the filler, or may be applied to a portion thereof. Examples of the surface-treated filler include a filler obtained by uniformly coating aluminum nitride with nanoparticles such as graphene, a filler obtained by uniformly coating a ceramics filler with silica, and a film-formation filler with water-resistance and insulating properties produced by forming a silicon oxide film on the surface of aluminum nitride by a sol-gel method, water glass or the like.

The α-butyl-ω-(2-trimethoxysilylethyl)polydimethylsiloxane used for the surface treatment of the filler has a weight average molecular weight (Mw) of 500 to 5,000, preferably 600 to 4,500, and more preferably 800 to 4,200. When the Mw is within this range, the percentage of adhesion of the α-butyl-ω-(2-trimethoxysilylethyl)polydimethylsiloxane to the filler can be within the range specified in the present invention.

Two or more types of α-butyl-ω-(2-trimethoxysilylethyl)polydimethylsiloxane having different Mw may be mixed and used.

The Mw is a polystyrene-equivalent molecular weight measured by gel permeation chromatography (GPC) using a standard polystyrene sample with a known molecular weight to create a calibration curve.

In the α-butyl-ω-(2-trimethoxysilylethyl)polydimethylsiloxane, the number of repeating units of dimethylsiloxane is an integer of preferably from 4 to 64, more preferably from 8 to 60, and further preferably from 10 to 56. When the number of repeating units of dimethylsiloxane is within this range, the adhesion percentage of the α-butyl-ω-(2-trimethoxysilylethyl)polydimethylsiloxane to the filler can be within the range specified in the present invention.

There is a functional group such as a hydroxyl group on the filler surface. This functional group and the trimethoxysilyl group of the α-butyl-ω-(2-trimethoxysilylethyl)polydimethylsiloxane chemically bond to fix a hydrolyzate of α-butyl-ω-(2-trimethoxysilylethyl)polydimethylsiloxane to the filler surface.

The adhesion percentage of the α-butyl-ω-(2-trimethoxysilylethyl)polydimethylsiloxane to the filler is from 20.0 to 50.0% by mass, preferably from 22.0 to 48.0% by mass, more preferably from 24.0 to 46.0% by mass, and further preferably from 25.0 to 45.0% by mass. When the adhesion percentage is 20.0% by mass or more, the heat conducting composition has good curability, and when the adhesion percentage is 50.0% by mass or less, the viscosity of the heat conducting composition is low even when the polymer component (A) is highly filled, and the cured product can have an appropriate hardness.

The adhesion percentage can be measured by a method conforming to JIS R1675:2007 “Combustion (high-frequency heating)—infrared absorption method”, and specifically by the method described in the Examples.

The content of the surface-treated filler (B) is from 30.0 to 96.0% by mass, preferably from 35.0 to 90.0% by mass, more preferably from 38.0 to 80.0% by mass, further preferably from 40.0 to 70.0% by mass, and still further preferably from 45.0 to 65.0% by mass based on the total amount of the heat conducting composition of this embodiment. When the content of the surface-treated filler (B) is 30.0% by mass or more, it is possible to obtain a heat conducting composition having a low viscosity even if the polymer component (A) is highly filled with the filler, and the cured product thereof can have an appropriate hardness. In addition, when the content of the surface-treated filler (B) is 96.0% by mass or less, the cured product of the heat conducting composition can have an appropriate hardness.

### (Method for Producing Surface-Treated Filler (B))

As the method for producing the surface-treated filler (B), for example, the filler is pre-treated with a treatment liquid containing α-butyl-ω-(2-trimethoxysilylethyl)polydimethylsiloxane having a weight average molecular weight of 500 to 5,000, an alcohol, and water, and then heat-treated at a temperature of 140 to 180° C.

For the filler and the α-butyl-ω-(2-trimethoxysilylethyl)polydimethylsiloxane, those described above can be used.

First, the treatment liquid containing α-butyl-ω-(2-trimethoxysilylethyl)polydimethylsiloxane having a weight average molecular weight of 500 to 5,000, an alcohol, and water is prepared.

Examples of the alcohol include ethanol, isopropanol, and butanol. These can be used alone or as a mixture of two or more types.

The concentration of the alcohol in the treatment liquid is preferably 99.5 to 99.9% by mass from the viewpoint of availability.

The water may be ion-exchanged water or distilled water.

In addition to the α-butyl-ω-(2-trimethoxysilylethyl)polydimethylsiloxane, an alcohol, and water, the treatment liquid may optionally include an acid such as hydrochloric acid and acetic acid; and an organic solvent such as acetone and methyl ethyl ketone (excluding an alcohol).

When the treatment liquid includes an acid, the hydrogen ion concentration of the treatment liquid is preferably from 2 to 10% by mass from the viewpoint of hydrolysis rate and silanol stability.

The amount of the α-butyl-ω-(2-trimethoxysilylethyl)polydimethylsiloxane (hereinafter also simply referred to as “polydimethylsiloxane”) added to the filler can be determined from the minimum coating area of the polydimethylsiloxane.

The minimum coating area of the polydimethylsiloxane can be calculated from the following formula (I). The area occupied by the trimethoxysilyl groups in the polydimethylsiloxane is 13×10⁻²⁰ m².

$$\begin{matrix}Minimum coating area ( {m}^{2} / g ) of \\ polydimethylsiloxane\end{matrix} = \frac{\begin{matrix}Area ( {m}^{2} ) occupied by the \\ trimethoxysilyl groups in \\ polydimethylsiloxane \times \\ 6.02 \times {10}^{23}\end{matrix}}{\begin{matrix}Weight average molecular \\ weight of polydimethylsiloxane\end{matrix}} \qquad ( I )$$

The amount of the α-butyl-ω-(2-trimethoxysilylethyl)polydimethylsiloxane added can be calculated from the following formula (II).

$$\begin{matrix}Amount ( g ) of \\ polydimethylsiloxane added\end{matrix} = \frac{\begin{matrix}BET specific surface \\ are ( {m}^{2} / g ) of filler \times \\ amount ( g ) of filler\end{matrix}}{\begin{matrix}Minimum coating \\ are ( {m}^{2} / g ) of \\ polydimethylsiloxane\end{matrix}} \times \frac{Coverage ( \% )}{100} \qquad ( II )$$

In formula (II), the coverage is the theoretical amount of polydimethylsiloxane coating the filler. From the viewpoint of ease of filling, the coverage is preferably from 10 to 100%, and more preferably from 20 to 100%. When the coverage is 20% or more, foaming of the composition containing the surface-treated filler can be suppressed.

The alcohol content is preferably from 150 to 400 parts by mass, more preferably from 200 to 350 parts by mass, and further preferably from 200 to 300 parts by mass based on 100 parts by mass of the α-butyl-ω-(2-trimethoxysilylethyl)polydimethylsiloxane. When the alcohol content is 150 parts by mass or more, the treatment liquid can be homogenized (compatibilized), and when the alcohol content is 400 parts by mass or less, a slurry can be formed after the treatment liquid is added to the filler.

The water content is preferably from 0.5 to 10 parts by mass, more preferably from 0.8 to 8 parts by mass, and further preferably from 1 to 6 parts by mass based on 100 parts by mass of the α-butyl-ω-(2-trimethoxysilylethyl)polydimethylsiloxane. When the water content is 0.5 parts by mass or more, hydrolysis of the trimethoxy group proceeds, and when the water content is 10 parts by mass or less, the treatment liquid can be homogenized (compatibilized).

When the treatment liquid includes an organic solvent (excluding an alcohol), the content of the organic solvent is preferably from 50 to 300 parts by mass, more preferably from 100 to 250 parts by mass, and further preferably from 100 to 200 parts by mass based on 100 parts by mass of the α-butyl-ω-(2-trimethoxysilylethyl)polydimethylsiloxane. When the organic solvent content is 50 parts by mass or more, the treatment liquid can be homogenized (compatibilized), and when the organic solvent content is 300 parts by mass or less, a slurry can be formed after the treatment liquid is added to the filler.

In a sealable container, the α-butyl-ω-(2-trimethoxysilylethyl)polydimethylsiloxane, the alcohol, the water, and if necessary, the acid and organic solvent (excluding an alcohol) are mixed. The order of the mixing of these compounds is not particularly limited, and the compounds may be mixed in any order.

The mixing can be carried out by stirring with a motor equipped with a stirring blade or with a magnetic stirrer, or by mixing each component in a container and rotating the container with a mixing rotor.

The mixing is preferably carried out at from 23 to 80° C. for from 4 to 100 hours, and more preferably at from 23 to 50° C. for from 4 to 72 hours.

Next, pretreatment is performed by adding the treatment liquid to the filler and stirring.

Examples of the stirring device include a rotation and revolution stirring device, a Nauta mixer, a high-speed mixer, a Henschel mixer, and a planetary mixer.

The stirring is preferably carried out at from 20 to 70° C. for from 1 to 120 minutes, and more preferably at from 23 to 50° C. for from 1 to 30 minutes.

After stirring, air drying may be performed for from 4 to 24 hours. The air-drying may be carried out by simply leaving at room temperature (25° C.), or if necessary, it may be carried out in a hot air circulating oven at a temperature of from 50 to 80° C.

After the pretreatment, a heat treatment is performed at a temperature of from 140 to 180° C., and the treatment liquid is baked.

When the heat treatment temperature is 140° C. or higher, the adhesion percentage of the α-butyl-ω-(2-trimethoxysilylethyl)polydimethylsiloxane to the filler can be increased, and when the heat treatment temperature is 180° C. or lower, degradation of the α-butyl-ω-(2-trimethoxysilylethyl)polydimethylsiloxane can be prevented. The heat treatment temperature is preferably from 145 to 175° C., and more preferably from 150 to 170° C.

Further, the heat treatment time is preferably from 2 to 6 hours, and more preferably from 2 to 5 hours. If the heat treatment time is 2 hours or more, the surface treatment of the filler with α-butyl-ω-(2-trimethoxysilylethyl)polydimethylsiloxane can be sufficiently performed, and the heat temperature time is within 6 hours, coloration due to thermal degradation of the surface-treated filler can be suppressed.

The surface-treated filler (B) obtained in this way may be washed with water or an alcohol. Examples of the alcohol used for the washing include ethanol, and propanol.

### [Silicon-Containing Oxide-Coated Nitride (C)]

The silicon-containing oxide-coated nitride (C) used in this embodiment is a filler having a nitride and a silicon-containing oxide coating that coats the nitride.

Examples of the nitride that constitutes the silicon-containing oxide-coated nitride (C) include metal nitrides. Examples of the metal nitride include aluminum nitride. The aluminum nitride, and known products such as commercially available products can be used. The aluminum nitride may be obtained by any production method, and may be obtained, for example, by a direct nitriding method in which metallic aluminum powder and nitrogen or ammonia are directly reacted, or by a reduction nitridation method in which a nitriding reaction is performed at the same time as heating alumina in a nitrogen or ammonia atmosphere while reducing with carbon.

The following description will use aluminum nitride as an example of the nitride.

The shape of the aluminum nitride is not particularly limited, and examples thereof include irregular (broken angular), spherical, elliptical, and plate-like (scale-like).

Further, the aluminum nitride has a cumulative volume-based 50% particle size of preferably from 10 to 150 μm, more preferably from 12 to 100 μm, and further preferably from 15 to 80 μm.

The specific surface area of the aluminum nitride determined by the BET method is preferably from 0.03 to 3.5 m²/g, more preferably from 0.04 to 3.2 m²/g, and further preferably 0.05 to 3.0 m²/g, from the viewpoint of the filling properties into the polymer component (A).

The specific surface area of the aluminum nitride can be measured by the BET single-point method based on nitrogen adsorption using a specific surface area measurement apparatus, and specifically by the method described in the Examples.

From the viewpoint of improving moisture resistance, the aluminum nitride preferably has a silicon-containing oxide coating covering its surface. Further, by having a silicon-containing oxide coating covering its surface, the aluminum nitride has improved water resistance and can suppress the generation of ammonia caused by hydrolysis, and is thus less likely to become a factor in inhibiting the curing of the polymer component (A). The silicon-containing oxide coating may cover a part or the entire surface of the aluminum nitride, and preferably covers the entire surface of the aluminum nitride.

Since aluminum nitride have excellent thermal conductivity, the aluminum nitride having a silicon-containing oxide coating on its surface (hereinafter also referred to as “silicon-containing oxide-coated aluminum nitride”) also has excellent thermal conductivity.

Examples of the “silicon-containing oxide” for the silicon-containing oxide coating and silicon-containing oxide-coated aluminum nitride particles include silica and oxides including silicon and aluminum.

In the silicon-containing oxide-coated aluminum nitride, from the viewpoints of moisture resistance and thermal conductivity, the coverage of the silicon-containing oxide coating that covers the surface of the aluminum nitride as determined by LEIS analysis is preferably from 15% to 100%, more preferably from 15% to 95%, further preferably from 15% to 90%, and particularly preferably from 15% to 85%.

The coverage (%) determined by LEIS (Low Energy Ion Scattering) analysis of the silicon-containing oxide coating (SiO₂) that covers the surface of the aluminum nitride can be determined by the following formula:

(S_{Al}(AlN)−S_{Al}(AlN+SiO₂))/S_{Al}(AlN)×100

wherein S_{Al}(AlN) is the area of the Al peak of the aluminum nitride, and S_{Al}(AlN+SiO₂) is the area of the Al peak of the silicon-containing oxide-coated aluminum nitride. The area of the Al peak can be determined from analysis by means of low energy ion scattering (LEIS), which is a measurement method using an ion source and a noble gas as probes. LEIS is a technique using a noble gas of several keV as the incident ion, being an evaluation method permitting a composition analysis of the outermost surface (reference: The TRC News 201610-04 (October 2016)).

The coverage of the silicon-containing oxide coating covering the surface of FAN-f80-A1, which is an example of the aluminum nitride, was 84% by LEIS analysis.

An example of a method for forming a silicon-containing oxide coating on aluminum nitride includes a method having a first step of covering the surface of the aluminum nitride with a siloxane compound having a structure represented by the following formula (1), and a second step of heating the aluminum nitride covered with the siloxane compound at a temperature of 300° C. or more and 900° C. or less.

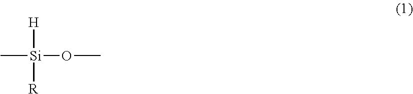

In the formula (1), R is an alkyl group having 4 or less carbon atoms.

The structure represented by the formula (1) is a hydrogen siloxane structural unit having a Si—H bond. In the formula (1), R is an alkyl group having 4 or less carbon atoms, that is, a methyl group, an ethyl group, a propyl group, or a butyl group, preferably a methyl group, an ethyl group, an isopropyl group, or a t-butyl group, more preferably a methyl group.

As the siloxane compound, preferable is an oligomer or a polymer including a structure represented by the formula (1) as a repeating unit. The siloxane compound may be any of linear, branched, or cyclic. The weight average molecular weight of the siloxane compound is preferably from 100 to 2,000, more preferably from 150 to 1,000, further preferably from 180 to 500, from the viewpoint of ease of formation of a silicon-containing oxide coating having a uniform coating thickness. The weight average molecular weight is a value in terms of polystyrene, obtained by gel permeation chromatography (GPC).

As the siloxane compound, preferably used are/is a compound represented by the following formula (2) and/or a compound represented by the following formula (3).

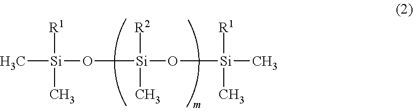

In the formula (2), R¹ and R² are each independently a hydrogen atom or a methyl group, and at least either of R¹ and R² is a hydrogen atom. m is an integer of 0 to 10, and from the viewpoint of commercial availability and the boiling point, is preferably 1 to 5, more preferably 1.

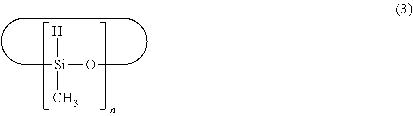

In the formula (3), n is an integer of 3 to 6, preferably from 3 to 5, more preferably 4.

As the siloxane compound, particularly preferable is a cyclic hydrogen siloxane oligomer in which n is 4 in the formula (3), from the viewpoint of ease of formation of a favorable silicon-containing oxide coating.

In the first step, the surface of the aluminum nitride is covered with a siloxane compound having a structure represented by the formula (1).

In the first step, as long as the surface of the aluminum nitride can be covered with a siloxane compound having a structure represented by the formula (1), the process is not particularly limited. Examples of the process for the first step include a dry mixing method in which, using a common powder mixing apparatus, dry mixing is made by adding the siloxane compound by spraying while the raw material aluminum nitride is stirred to thereby coat the aluminum nitride.

Examples of the powder mixing apparatus include a Henschel mixer (manufactured by Nippon Coke & Engineering Co., Ltd.), a rotary vessel-type V blender, a ribbon blender having mixing blades such as a double cone-type blender, a screw-type blender, a hermetic rotary kiln, and stirring by means of a stirring bar of a hermetic container using magnet coupling. The temperature conditions are not particularly limited, and are preferably in the range of from 10 to 200° C., more preferably in the range of from 20 to 150° C., and further preferably in the range of from 40° C. to 100° C.

A vapor phase adsorption method also may be used in which vapor of the siloxane compound singly or a mixed gas thereof with an inert gas such as nitrogen gas is caused to be attached or deposited onto the aluminum nitride surface left to stand. The temperature conditions are not particularly limited, and are preferably in the range of from 10 to 200° C., more preferably in the range of from 20 to 150° C., and further preferably in the range of from 40 to 100° C. If further necessary, the inside of the system may be pressurized or depressurized. As an apparatus that can be used in this case, preferable is an apparatus which is a hermetic system and in which the gas in the system can be easily replaced. Examples thereof that can be used include a glass container, a desiccator, and a CVD apparatus.

The amount of the siloxane compound used in the first step is not particularly limited. In the aluminum nitride covered with the siloxane compound obtained in the first step, the amount coated with the siloxane compound is preferably 0.1 mg or more and 1.0 mg or less, more preferably in the range of 0.2 mg or more and 0.8 mg or less, further preferably in the range of 0.3 mg or more and 0.6 mg or less per 1 m² of the surface area calculated from the specific surface area (m²/g) of the aluminum nitride determined by the BET method. When the amount coated with the siloxane compound is within the range, it is possible to obtain aluminum nitride having a silicon-containing oxide coating having a uniform coating thickness.

The amount coated with the siloxane compound per 1 m² of the surface area calculated from the specific surface area (m²/g) of the aluminum nitride determined by the BET method can be determined by dividing the difference between the masses of the aluminum nitride before and after coated with the siloxane compound by the surface area (m²) calculated from the specific surface area (m²/g) of the aluminum nitride determined by the BET method.

In the second step, the aluminum nitride coated with the siloxane compound obtained in the first step is heated at a temperature of 300° C. or more and 800° C. or less. This enables the silicon-containing oxide coating to be formed on the aluminum nitride surface. The heating temperature is more preferably 400° C. or more, further preferably 500° C. or more.

From the viewpoint that a sufficient reaction time is secured and also a favorable silicon-containing oxide coating is efficiently formed, the heating time is preferably 30 minutes or more and 6 hours or less, more preferably 45 minutes or more and 4 hours or less, further preferably in the range of 1 hour or more and 2 hours or less. As for the atmosphere at the time of heating treatment, the heating treatment is preferably performed in an atmosphere containing oxygen gas, for example, in the atmospheric air (in the air).

The particles of the silicon-containing oxide-coated aluminum nitride may be partially fused to one another after the heat treatment in the second step, and in such a case, disintegration using a common pulverizer, for example, a roller mill, a hammer mill, a jet mill, or a ball mill enables silicon-containing oxide-coated aluminum nitride having no sticking or clumping to be obtained.

After completion of the second step, the first step and the second step may be performed in the order mentioned. That is, a step of performing the first step and the second step in the order mentioned may be repeatedly performed.

The content of the silicon-containing oxide-coated nitride (C) is from 3.0 to 55.0% by mass, preferably from 5.0 to 54.0% by mass, more preferably from 10.0 to 52.0% by mass, further preferably from 20.0 to 50.0% by mass, and still further preferably from 30.0 to 50.0% by mass based on the total amount of the heat conducting composition of this embodiment. When the content of the silicon-containing oxide-coated nitride (C) is 3.0% by mass or more, a heat conducting composition having a low viscosity can be obtained even when the polymer component (A) is highly filled with the filler, and the cured product can have an appropriate hardness. Moreover, when the content of the silicon-containing oxide-coated nitride (C) is 55.0% by mass or less, the cured product of the heat conducting composition can have an appropriate hardness.

### [Other Fillers]

From the viewpoint of improving thermal conductivity, the heat conducting composition of this embodiment preferably contains a filler other than the above-described surface-treated filler (B) (hereinafter simply referred to as “other filler”). The other filler may or may not be surface-treated.

Examples of the other filler include metal oxides, metal nitrides, and metal hydroxides.

Examples of the metal oxide include zinc oxide, alumina, magnesium oxide, silicon dioxide, and iron oxide. Examples of the metal nitride include boron nitride, aluminum nitride, and silicon nitride. Examples of the metal hydroxide include aluminum hydroxide, and magnesium hydroxide.

Considering the balance between thermal conductivity and cost, aluminum oxide (alumina) is preferable, and α-alumina is particularly preferable because of its high thermal conductivity. From the viewpoint of high thermal conductivity, aluminum nitride and boron nitride are suitably used, and from the viewpoint of low cost, silica, quartz powder, and aluminum hydroxide are suitably used.

The other filler has a cumulative volume-based 50% particle size of preferably more than 30 μm and 100 μm or less, more preferably from 35 to 90 μm, further preferably 40 to 85 μm, and still further preferably from 45 to 80 μm, from the viewpoint of improving thermal conductivity and increasing the filling factor.

When the heat conducting composition of this embodiment contains the other filler, the content of the other filler is preferably from 30 to 50% by mass, more preferably from 34 to 48% by mass, and further preferably from 38 to 46% by mass based on the total amount of the heat conducting composition. When the content of the other filler is 30% by mass or more, the thermal conductivity can be further increased, and when the content is 50% by mass or less, the hardness of the cured product can be lowered to an appropriate hardness.

In addition to the above components, the heat conducting composition of this embodiment can optionally contain additives such as a heat-resistant agent, a flame retardant, a plasticizer, a vulcanizing agent, a silane coupling agent, a dispersant, and a reaction accelerator within a range that does not affect the cured form and physical properties and does not interfere with the effects of the present invention.

When additives are used, the amount added is preferably from 0.05 to 10.0% by mass, more preferably from 0.10 to 8.0% by mass, and further preferably from 0.15 to 5.0% by mass based on the total amount of the heat conducting composition.

In the heat conducting composition of this embodiment, the total content of the polymer component (A), the surface-treated filler (B), and the silicon-containing oxide-coated nitride (C) is preferably from 90 to 100% by mass, more preferably from 92 to 100% by mass, and further preferably from 95 to 100% by mass.

The heat conducting composition of this embodiment can be obtained by charging the polymer component (A), the surface-treated filler (B), the silicon-containing oxide-coated nitride (C), and the other filler and additives that are optionally added, into a stirring device, stirring, and kneading. The stirring device is not particularly limited, and examples thereof include a twin roll, a kneader, a planetary mixer, a high-speed mixer, and a rotation/revolution stirrer.

The heat conducting composition of this embodiment has a viscosity at 30° C. of preferably from 100 to 1500 Pa·s, more preferably from 100 to 1000 Pa·s, and further preferably from 100 to 800 Pa·s.

The viscosity can be measured by a method conforming to JIS K7210:2014 using a flow viscometer, and specifically by the method described in the Examples.

Since the heat conducting composition of this embodiment can obtain a cured product having a low viscosity, a high thermal conductivity, and appropriate hardness, it can be suitably used in exothermic electronic parts such as electronic devices, personal computers, and automotive ECUs and batteries.

### <Cured Product of Heat Conducting Composition>

The heat conducting composition of this embodiment can provide a cured product by, for example, reacting the thermally conductive composition at room temperature (23° C.) or by heating. When the polymer component (A) is a room-temperature curable polymer, the heat conducting composition may be cured by leaving it at a temperature of from 20 to 25° C. for about 1 to 10 days.

When the polymer component (A) is an addition-type silicone rubber, the cured product can be obtained, for example, by reacting at room temperature (23° C.) or by heating. When the thermally conductive composition containing the addition-type silicone rubber as the polymer component (A) is cured by heating, the heating is performed without pressurization at a temperature of 50° C. or higher and 150° C. or lower for 5 minutes or more and 20 hours or less, and more preferably at a temperature of 60° C. or higher and 120° C. or lower for 10 minutes or more and 10 hours or less.

When the polymer component (A) is a peroxide-type silicone rubber, the cured product can be obtained, for example, by reacting at room temperature (23° C.) or by heating. When the thermally conductive composition containing the peroxide-type silicone rubber as the polymer component (A) is cured by heating, it is preferable to carry out primary vulcanization at a pressure of from 0.1 to 1.0 MPa, a temperature of 50° C. or higher and 150° C. or lower for 5 minutes or more and 2 hours or less and then carry out secondary vulcanization without pressurization at a temperature of 100° C. or higher and 250° C. or lower for 1 hour or more and 10 hours or less, and more preferable to carry out primary vulcanization at a pressure of from 0.1 to 0.6 MPa, a temperature of 60° C. or higher and 120° C. or lower for 10 minutes or more and 1 hour or less and then carry out secondary vulcanization without pressurization at a temperature of 150° C. or higher and 230° C. or lower for 2 hours or more and 6 hours or less.

The cured product of the heat conducting composition of the present embodiment preferably has a thermal conductivity of 3.0 W/m·K or more, and more preferably 3.2 W/m·K or more.

The thermal conductivity can be measured by a method conforming to ISO22007-2:2008, and specifically by the method described in the Examples.

The cured product of the heat conducting composition of the present embodiment preferably has a hardness measured according to the hardness test (Shore 00) of ASTM D2240 of from 20 to 80, more preferably from 22 to 70, and further preferably from 25 to 60. When the Shore 00 hardness is within this range, the cured product can have an appropriate hardness.

The Shore 00 hardness can be specifically measured by the method described in the Examples.

The cured product of the heat conducting composition of the present embodiment preferably has an A hardness measured according to the hardness test (type A) of JIS K7312:1996 of from 60 to 90, more preferably from 65 to 90, and further preferably from 70 to 85. When the A hardness is within this range, the cured product can have an appropriate hardness.

The A hardness can be specifically measured by the method described in the Examples.

### EXAMPLES

The present invention will now be described in detail with reference to examples, but the present invention is not limited by these examples.

### (Raw Material Compounds)

The details of the raw material compounds used in Examples 1 to 9 and Comparative Examples 1 to 8 are as follows.

### [Filler]

AES-12: Alumina, manufactured by Sumitomo Chemical Co., Ltd., D50=0.5 μm, specific surface area (BET method)=5.8 m²/g, thermal conductivity=25 W/m·K, specific gravity=3.98 g/cm³
BAK-5: Alumina, manufactured by Shanghai Hakuto Co., Ltd., D50=5 μm, specific surface area (BET method)=0.4 m²/g, thermal conductivity=25 W/m·K, specific gravity=3.98 g/cm³
AKP30: Alumina, manufactured by Sumitomo Chemical Co., Ltd., D50=0.32 μm, specific surface area (BET method)=7.0 m²/g, thermal conductivity=25 W/m·K, specific gravity=3.98 g/cm³
AA-3: Alumina, manufactured by Sumitomo Chemical Co., Ltd., D50=3.0 μm, specific surface area (BET method)=0.54 m²/g, thermal conductivity=25 W/m·K, specific gravity=3.98 g/cm³
AA-18: Alumina, manufactured by Sumitomo Chemical Co., Ltd., D50=20 μm, specific surface area (BET method)=0.15 m²/g, thermal conductivity=25 W/m·K, specific gravity=3.98 g/cm³
TFZ-S60X: Aluminum nitride, manufactured by Toyo Aluminum K.K, D50=55 μm, specific surface area (BET method)=0.1 m²/g, thermal conductivity=170 W/m·K, specific gravity=3.26 g/cm³
TFZ-S30P: Aluminum nitride, manufactured by Toyo Aluminum K.K, D50=30 μm, specific surface area (BET method)=0.2 m²/g, thermal conductivity=170 W/m·K, specific gravity=3.26 g/cm³
TFZ-N15P: Aluminum nitride, manufactured by Toyo Aluminum K.K, D50=15 μm, specific surface area (BET method)=0.9 m²/g, thermal conductivity=170 W/m·K, specific gravity=3.26 g/cm³
FAN-f80-A1: Aluminum nitride, manufactured by Furukawa Denshi Co., Ltd, D50=76 μm, specific surface area (BET method)=0.05 m²/g, thermal conductivity=170 W/m·K, specific gravity=3.26 g/cm³

The D50, the specific surface area, and the thermal conductivity of the filler were measured by the following measurement methods.

### (1) D50

The D50 was determined from the particle size (50% particle size D50) at which the cumulative volume was 50% in a particle size distribution measured using a laser diffraction particle size distribution analyzer (manufactured by MicrotracBEL Corp., trade name: MT3300EXII).

### (2) Specific Surface Area

The specific surface area was measured using a specific surface area measurement apparatus (manufactured by Mountech Co., Ltd., trade name: Macsorb MS30) by the single-point BET method based on nitrogen adsorption.

### (3) Thermal Conductivity

50 g of filler was pulverized, then paraffin was added in an amount of 5% by mass of the filler. The mixture was kneaded, the resulting kneaded product was placed in a mold with a diameter of 25 mm and a thickness of 8 mm, and molded by cold pressing. Next, the temperature was raised from room temperature (20° C.) to 200° C. over 1 hour in an electric furnace, and degreasing was performed for 2 hours while maintaining the temperature at 200° C. Subsequently, the temperature was raised at a rate of temperature increase of 400° C./hour, firing was carried out at a temperature of 1580° C. for 4 hours, and the fired product was cooled by natural cooling for 4 hours or more to obtain a sintered body. The thermal conductivity of the obtained sintered body was measured according to ISO22007-2:2008 using a hot disk method thermophysical property measuring device (manufactured by Kyoto Electronics Industry Co., Ltd., trade name TPS 2500 S).

### [Polymer Component (A)]

DOWSIL™ CY52-276: Solution A (mixture of vinyl group-containing dimethyl silicone rubber and platinum catalyst) and solution B (mixture of vinyl group-containing dimethyl silicone rubber and cross-linking agent), manufactured by Dow Toray Co., Ltd., viscosity at 25° C.=780 mPa·s, thermal conductivity=0.2 W/m·K, specific gravity=0.97 g/cm³
DOWSIL™ EG-3100: Silicone rubber, manufactured by Dow Toray Co., Ltd., viscosity at 25° C.=320 mPa·s, thermal conductivity=0.2 W/m·K, specific gravity=0.97 g/cm³
TSE201: Vinyl group-containing dimethyl silicone rubber, manufactured by Momentive, viscosity at 25° C.=1,000,000 to 3,000,000 mPa·s, thermal conductivity=0.20 W/m·K, specific gravity=0.97 g/cm³

### [Other Components]

KN320: Flame retardant, manufactured by Toda Kogyo Corp.
TC-1: Vulcanizing agent, manufactured by Momentive

The viscosity and thermal conductivity of the polymer component (A) were measured by the following measurement methods. In the measurement of DOWSIL™ CY52-276, a mixture of the solution A and the solution B having a mass ratio of 1:1 was used.

### (1) Viscosity

The viscosities of the DOWSIL™ CY52-276 and DOWSIL™ EG-3100 were measured based on JIS Z8803:2011 “Methods for measuring the viscosity of liquids” using a rotational viscometer (manufactured by Toki Sangyo Co., Ltd., product name: TVB-10, rotor No. 3) at 25° C. and a rotation speed of 20 rpm. Further, the viscosity of the TSE201 was measured in accordance with JIS K7210:2014 using a flow viscometer (GFT-100EX, manufactured by Shimadzu Corporation) at a temperature of 30° C., a die hole size (diameter) of 1.0 mm, and a test force of 10 (weight 1.8 kg).

### (2) Thermal Conductivity

The thermal conductivity of the polymer component (A) was measured in accordance with ISO22007-2:2008 using a hot disk method thermophysical property measuring device (manufactured by Kyoto Electronics Industry Co., Ltd., trade name TPS 2500 S).

### [α-Butyl-ω-(2-Trimethoxysilylethyl)Polydimethylsiloxane]

Surface treatment agent 1: α-butyl-ω-(2-trimethoxysilylethyl)polydimethylsiloxane, weight average molecular weight=3,000, number of repeating units of dimethylsiloxane=37, viscosity at 25° C.=25 mPa·s, minimum coating area=26.1 m²/g, specific gravity=0.97 g/cm³
Surface treatment agent 2: α-butyl-ω-(2-trimethoxysilylethyl)polydimethylsiloxane, weight average molecular weight=1,400, number of repeating units of dimethylsiloxane=15.3, viscosity at 25° C.=16 mPa·s, minimum coating area=55.9 m²/g, specific gravity=0.97 g/cm³
Surface treatment agent 3: α-butyl-ω-(2-trimethoxysilylethyl)polydimethylsiloxane, weight average molecular weight=4,000, number of repeating units of dimethylsiloxane=50, viscosity at 25° C.=40 mPa·s, minimum coating area=19.6 m²/g, specific gravity=0.97 g/cm³

### [Silane Coupling Agent]

Surface treatment agent 4: KBM-3103C, decyltrimethoxysilane, manufactured by Shin-Etsu Chemical Co., Ltd., molecular weight=262.5, minimum coating area=298 m²/g, specific gravity=0.89 g/cm³
Surface treatment agent 5: Dynasylan (registered trademark) 9116, hexadecyltrimethoxysilane, molecular weight=346.6, manufactured by Evonik Japan Co., Ltd., minimum coating area=226 m²/g, specific gravity=0.89 g/cm³

The minimum coating area of the surface treatment agent was calculated using the following formula (i).

In formula (i), the area occupied by the trimethoxysilyl group is 13×10⁻²⁰ m² for all of the α-butyl-ω-(2-trimethoxysilylethyl)polydimethylsiloxane, the decyltrimethoxysilane, and the hexadecyltrimethoxysilane.

$$\begin{matrix}Minimum coating \\ are ( {m}^{2} / g )\end{matrix} = \frac{\begin{matrix}Area ( {m}^{2} ) occupied by the trimethoxysilyl \\ groups in surface treatment agent \times 6.02 \times {10}^{23}\end{matrix}}{\begin{matrix}Weight average molecular weight of surface \\ treatment agent\end{matrix}} \qquad ( i )$$

### Synthesis Example 1: Production of Surface-Treated Filler (B1)

### (1) Preparation of Treatment Liquid

The amount of surface treatment agent 1 used was calculated from the following formula (ii).

In formula (ii), the filler coverage was 33.3%.

$$\begin{matrix}Amount ( g ) of surface \\ treatment agent\end{matrix} = \frac{\begin{matrix}BET specific surface area ( {m}^{2} / g ) of \\ filler \times amount ( g ) of filler\end{matrix}}{\begin{matrix}Minimum coating area ( {m}^{2} / g ) of \\ surface treatment agent\end{matrix}} \times \frac{Coverage ( \% )}{100} \qquad ( ii )$$

3.22 parts by mass of surface treatment agent 1, 8.05 parts by mass of isopropanol, and 0.06 parts by mass of ion-exchanged water were added to a vial, sealed, and mixed for 3 days at a temperature of 25° C. and a rotation speed of 70 rpm using a mix rotor (VMR-5A, manufactured by AS ONE CORPORATION) to obtain a treatment liquid.

### (2) Surface Treatment of Filler

As the filler, 40.0 parts by mass of AES-12 (alumina) and 50.0 parts by mass of BAK-5 (alumina) were stirred and mixed at a temperature of 25° C. for 20 seconds at a rotation speed of 2000 rpm using a rotation/revolution mixer (ARE-310, manufactured by THINKY CORPORATION). To the resulting mixture, the entire amount of the treatment liquid obtained in (1) above was added with a dropper, and using the rotation/revolution mixer, the mixture was stirred and mixed three times at a temperature of 25° C. and a rotation speed of 2000 rpm for 20 seconds, then air-dried at room temperature (25° C.) for 1 day to volatilize the solvent. Next, after heat treating at a temperature of 160° C. for 4 hours and baking the surface treatment agent 1, the resultant product was cooled at room temperature (25° C.) to obtain a surface-treated filler (B1) surface-treated with surface treatment agent 1.

### (3) Washing of Surface-Treated Filler (B1)

The obtained surface-treated filler (B1) was washed by the following operation.

20 parts by mass of the surface-treated filler (B1) was placed in a centrifuge tube, 10 parts by mass of isopropanol was added, the tube was capped, shaken up and down by hand for 30 seconds, and then shaken at 3000 rpm for 10 minutes using a centrifuge (CN-2060, manufactured by AS ONE CORPORATION) to cause the surface-treated filler (B1) to sediment. After discarding the supernatant liquid and loosening the sediment, 10 parts by weight of isopropanol was added, the tube was capped, shaken up and down by hand for 30 seconds, and then shaken at 3000 rpm for 10 minutes using the centrifuge to cause the surface-treated filler (B1) to sediment. The same procedure was repeated once more, the supernatant was discarded, and the sediment was left in the centrifuge tube to air-dry for one day. Then, the sediment was dried at a temperature of 100° C. for 1 hour.

### Synthesis Examples 2 to 5: Production of Surface-Treated Fillers (B2), (B3) and Surface-Treated Fillers (b1), (b2)

The surface-treated fillers of Synthesis Examples 2 to 5 (B2), (B3), (b1) and (b2) were obtained in the same manner as in Synthesis Example 1, except that the type and amount added of the treatment liquid were changed to as shown in Table 1 and the heat treatment temperature and the heat treatment time were changed to as shown in Table 1.

The amount of the surface treatment agent used in Synthesis Examples 2 and 3 was calculated based on a filler coverage of 33.3% in formula (ii). The amount of the surface treatment agent used in Synthesis Examples 4 and 5 was calculated based on a filler coverage of 100% in formula (ii).

### Synthesis Example 6: Production of Surface-Treated Filler (B4)

### (1) Preparation of Treatment Liquid

The amount of surface treatment agent 1 used was calculated from the above formula (ii). In formula (ii), the filler coverage was 33.3%. 2.76 parts by mass of surface treatment agent 1, 6.90 parts by mass of isopropanol, and 0.05 parts by mass of ion-exchanged water were added to a vial, sealed, and mixed for 3 days at a temperature of 25° C. and a rotation speed of 70 rpm using a mix rotor (VMR-5A, manufactured by AS ONE CORPORATION) to obtain a treatment liquid.

### (2) Surface Treatment of Filler

As the filler, 60 parts by mass of AKP30 (alumina), 60 parts by mass of AA-3 (alumina), and 10 parts by mass of AA-18 (alumina) were stirred and mixed at a temperature of 25° C. for 20 seconds at a rotation speed of 2000 rpm using a rotation/revolution mixer (ARE-310, manufactured by THINKY CORPORATION). To the resulting mixture, the entire amount of the treatment liquid obtained in (1) above was added with a dropper, and using the rotation/revolution mixer, the mixture was stirred and mixed three times at a temperature of 25° C. and a rotation speed of 2000 rpm for 20 seconds, then air-dried at room temperature (25° C.) for 1 day to volatilize the solvent. Next, after heat treating at a temperature of 160° C. for 4 hours and baking the surface treatment agent 1, the resultant product was cooled at room temperature (25° C.) to obtain a surface-treated filler (B4) surface-treated with surface treatment agent 1.

### (3) Washing of Surface-Treated Filler (B4)

The obtained surface-treated filler (B4) was washed in accordance with the same procedure as in “(3) Washing of surface-treated filler (B1)” of Synthesis Example 1.

### Synthesis Example 7: Production of Surface-Treated Filler (b3)

The surface-treated filler (b3) of Synthesis Example 7 was obtained in the same manner as in Synthesis Example 6, except that the type and amount added of the treatment liquid were changed to as shown in Table 1 and the heat treatment temperature and the heat treatment time were changed to as shown in Table 1.

The amount of the surface treatment agent used in Synthesis Example 7 was calculated based on a filler coverage of 100% in formula (ii).

### Synthesis Example 8: Production of Surface-Treated Filler (B5)

### (1) Preparation of Treatment Liquid

The amount of surface treatment agent 1 used was calculated from the above formula (ii). In formula (ii), the filler coverage was 33.3%.

4.02 parts by mass of surface treatment agent 1, 10.6 parts by mass of isopropanol, and 0.07 parts by mass of ion-exchanged water were added to a vial, sealed, stirred and mixed for 3 days at a temperature of 25° C. and a rotation speed of 70 rpm using a mix rotor (VMR-5A, manufactured by AS ONE CORPORATION) to obtain a treatment liquid.

### (2) Surface Treatment of Filler

As the filler, 40 parts by mass of AKP30 (alumina) and 50 parts by mass of AA-3 (alumina) were stirred and mixed at a temperature of 25° C. for 20 seconds at a rotation speed of 2000 rpm using a rotation/revolution mixer (ARE-310, manufactured by THINKY CORPORATION). To the resulting mixture, the entire amount of the treatment liquid obtained in (1) above was added with a dropper, and using the rotation/revolution mixer, the mixture was stirred and mixed three times at a temperature of 25° C. and a rotation speed of 2000 rpm for 20 seconds, then air-dried at room temperature (25° C.) for 1 day to volatilize the solvent. Next, after heat treating at a temperature of 160° C. for 4 hours and baking the surface treatment agent 1, the resultant product was cooled at room temperature (25° C.) to obtain a surface-treated filler (B5) surface-treated with surface treatment agent 1.

### (3) Washing of Surface-Treated Filler (B5)

The obtained surface-treated filler (B5) was washed in accordance with the same procedure as in “(3) Washing of surface-treated filler (B1)” of Synthesis Example 1.

### Synthesis Example 9: Production of Surface-Treated Filler (b4)

The surface-treated filler (b4) of Synthesis Example 9 was obtained in the same manner as in Synthesis Example 8, except that the type and amount added of the treatment liquid were changed to as shown in Table 1 and the heat treatment temperature and the heat treatment time were changed to as shown in Table 1.

The amount of the surface treatment agent used in Synthesis Example 9 was calculated based on a filler coverage of 100% in formula (ii).

The obtained surface-treated fillers (B1) to (B5) and surface-treated fillers (b1) to (b4) were evaluated as follows. The results are shown in Table 1.

### [Adhesion Percentage of Surface Treatment Agent to Filler]

The adhesion percentage of the surface treatment agent was measured by a method conforming to JIS R1675:2007 “Combustion (high-frequency heating)—infrared absorption method”. The total carbon content of the surface treatment agent and the total carbon content of the surface-treated filler after washing were each measured, and the adhesion percentage was calculated from the following formula (iii).

The carbon content of surface treatment agent 1 was 32.73% by mass, the carbon content of surface treatment agent 2 was 33.13% by mass, the carbon content of surface treatment agent 3 was 32.65% by mass, the carbon content of surface treatment agent 4 was 70.91% by mass, and the carbon content of surface treatment agent 5 was 75.79% by mass.

$$\begin{matrix}Adhesion percentage \\ ( \% by mass ) to filler\end{matrix} = \frac{\begin{matrix}Total carbon content ( g ) of \\ surface - treated filler after washing\end{matrix}}{\begin{matrix}Total carbon content ( g ) of surface \\ treatment agent\end{matrix}} \times 100 \qquad ( iii )$$

TABLE 1

| | | | | | | | | Adhesion |
|---|---|---|---|---|---|---|---|---|
| | | | | | | | | percentage |
| | | | | | | | | (% by |
| | | | Treatment solution | | | | | mass) of |
| | | | | Water or | | Heat | Heat | surface |
| | | | Surface | aqueous | | treatment | treatment | treatment |
| | | | treatment | acetic acid | | temperature | time | agent to |
| | | Filler | agent | solution | Alcohol | (° C.) | (hours) | filler |
| Synthesis | Surface- | AES-12:BAK-5 = 4:5 | Surface- | Ion- | Isopropanol | 160 | 4 | 31.3 |
| Example | treated | (mass ratio) | treatment | exchanged | 8.05 parts | | | |
| 1 | filler | (AES-12: 40 parts by mass, | agent 1 | water | by mass | | | |
| | (B1) | BAK-5: 50 parts by mass) | 3.22 | 0.06 parts | | | | |
| | | | parts by | by mass | | | | |
| | | | mass | | | | | |
| Synthesis | Surface- | | Surface- | Ion- | Isopropanol | 160 | 4 | 44.3 |
| Example | treated | | treatment | exchanged | 3.75 parts | | | |
| 2 | filler | | agent 2 | water | by mass | | | |
| | (B2) | | 1.50 | 0.06 parts | | | | |
| | | | parts by | by mass | | | | |
| | | | mass | | | | | |
| Synthesis | Surface- | | Surface- | Ion- | Isopropanol | 160 | 4 | 29.6 |
| Example | treated | | treatment | exchanged | 10.7 parts | | | |
| 3 | filler | | agent 3 | water | by mass | | | |
| | (B3) | | 4.29 | 0.06 parts | | | | |
| | | | parts by | by mass | | | | |
| | | | mass | | | | | |
| Synthesis | Surface- | | Surface- | Ion- | Isopropanol | 120 | 2 | 64.1 |
| Example | treated | | treatment | exchanged | 2.33 parts | | | |
| 4 | filler | | agent 4 | water | by mass | | | |
| | (b1) | | 0.93 | 0.19 parts | | | | |
| | | | parts by | by mass | | | | |
| | | | mass | | | | | |
| Synthesis | Surface- | | Surface- | Ion- | Isopropanol | 120 | 2 | 53.3 |
| Example | treated | | treatment | exchanged | 3.10 parts | | | |
| 5 | filler | | agent 5 | water | by mass | | | |
| | (b2) | | 1.22 | 0.19 parts | | | | |
| | | | parts by | by mass | | | | |
| | | | mass | | | | | |
| Synthesis | Surface- | AKP30:AA-3:AA-18 = 6:6:1 | Surface- | Ion- | Isopropanol | 160 | 4 | 32.3 |
| Example | treated | (mass ratio) | treatment | exchanged | 6.90 parts | | | |
| 6 | filler | (AKP30: 60 parts by mass, | agent 1 | water | by mass | | | |
| | (B4) | AA-3: 60 parts by mass, | 2.76 | 0.05 parts | | | | |
| | | AA-18: 10 parts by mass) | parts by | by mass | | | | |
| | | | mass | | | | | |
| Synthesis | Surface- | | Surface- | Ion- | Isopropanol | 120 | 2 | 64.3 |
| Example | treated | | treatment | exchanged | 3.88 parts | | | |
| 7 | filler | | agent 4 | water | by mass | | | |
| | (b3) | | 1.55 | 0.28 parts | | | | |
| | | | parts by | by mass | | | | |
| | | | mass | | | | | |
| Synthesis | Surface- | AKP30:AA-3 = 4:5 | Surface- | Ion- | Isopropanol | 160 | 4 | 34.2 |
| Example | treated | (mass ratio) | treatment | exchanged | 10.6 parts | | | |
| 8 | filler | (AKP30: 40 parts by mass, | agent 1 | water | by mass | | | |
| | (B5) | AA-3: 50 parts by mass) | 4.02 | 0.07 parts | | | | |
| | | | parts by | by mass | | | | |
| | | | mass | | | | | |
| Synthesis | Surface- | | Surface- | Ion- | Isopropanol | 120 | 2 | 55.1 |
| Example | treated | | treatment | exchanged | 3.49 parts | | | |
| 9 | filler | | agent 5 | water | by mass | | | |
| | (b4) | | 1.39 | 0.22 parts | | | | |
| | | | parts by | by mass | | | | |
| | | | mass | | | | | |

### Synthesis Example 10: Production of Silicon-Containing Oxide-Coated Aluminum Nitride (C1)

Using a vacuum desiccator that was made of an acrylic resin having a plate thickness of 20 mm, had inner dimensions of 260 mm×260 mm×100 mm, and had a structure having two, upper and lower, stages divided by a partition having through holes, 100 g of aluminum nitride (TFZ-S60X) uniformly spread on a stainless tray was left to stand on the upper stage, and 20 g of 2,4,6,8-tetramethylcyclotetrasiloxane (D4H) (manufactured by Tokyo Chemical Industry Co., Ltd.) placed in a glass petri dish was left to stand on the lower stage. Thereafter, the vacuum desiccator was closed and heated in an oven at 80° C. for 30 hours. The operation was performed with safety measures taken, such as release of hydrogen gas generated by the reaction from the open valve attached to the desiccator. Next, the sample taken out of the desiccator was placed in an alumina crucible. The sample was subjected to heat treatment in the atmospheric air under conditions of 700° C. and 3 hours to obtain silicon-containing oxide-coated aluminum nitride (C1).

### Synthesis Example 11: Production of Silicon-Containing Oxide-Coated Aluminum Nitride (C2)

A silicon-containing oxide-coated aluminum nitride (C2) of Synthesis Example 12 was obtained in the same manner as in Synthesis Example 10, except that TFZ-S30P was used instead of TFZ-S60X as the aluminum nitride.

### Synthesis Example 12: Production of Silicon-Containing Oxide-Coated Aluminum Nitride (C3)

A silicon-containing oxide-coated aluminum nitride (C3) of Synthesis Example 11 was obtained in the same manner as in Synthesis Example 10, except that TFZ-N15P was used instead of TFZ-S60X as the aluminum nitride and heat treatment was carried out under conditions of 800° C. and 3 hours.

### Synthesis Example 13: Production of Silicon-Containing Oxide-Coated Aluminum Nitride (C4)

A silicon-containing oxide-coated aluminum nitride (C4) of Synthesis Example 13 was obtained in the same manner as in Synthesis Example 10, except that FAN-f80-A1 was used instead of TFZ-S60X as the aluminum nitride.

### Example 1

### (Production of Heat Conducting Composition)

A polyethylene container was charged with 75.0 parts by mass of vinyl group-containing dimethyl silicone rubber (DOWSIL™ CY52-276, a mixture of solution A and solution B in a mass ratio of 1:1) as the polymer component (A) and 900.0 parts by mass of the surface-treated filler (B1) as a surface-treated filler, and the mixture was stirred and mixed with a rotation/revolution mixer (manufactured by THINKY CORPORATION) at a rotation speed of 2000 rpm for 30 seconds. After cooling, the mixture was loosened, 772.4 parts by mass of silicon-containing oxide-coated aluminum nitride (C1) was further added as a silicon-containing oxide-coated nitride, and the mixture was stirred and mixed with the rotation/revolution mixer at a rotation speed of 2000 rpm for 30 seconds to obtain the heat conducting composition of Example 1.

### (Sheet Production)

A defoamed heat conducting composition was placed on a polyester film having a thickness of 0.1 mm that had been subjected to a fluorine release treatment, then a polyester film having a thickness of 0.1 mm was placed thereon to prevent air from entering, molding was carried out with a rolling roll, curing was carried out at 120° C. for 60 minutes, and the cured sheet was further left at room temperature (23° C.) for one day, whereby a sheet (cured product of the heat conducting composition) having a thickness of 2.0 mm was obtained.

### Examples 2 and 3 and Comparative Examples 1 to 3: Production of Heat Conducting Composition and Sheet

The heat conducting composition and sheet of each example and comparative example were produced in the same manner as in Example 1, except that the types and amounts of each component were changed to as shown in Table 2. In Comparative Example 3, the filler could not be filled into the polymer component (A), and a sheet could not be produced.

### (Evaluation)

Characteristics were measured using the heat conducting composition and the sheet of the heat conducting composition obtained in each example and comparative example under the measurement conditions shown below. The results are shown in Table 2.

### (1) Filler Content (% by Volume)

The filler content (% by volume) based on the total heat conducting composition was calculated using the following formula (iv).

In formula (iv), the volume of the filler is the total of the volume of the surface-treated filler (B), the volume of the silicon-containing oxide-coated nitride (C), the volume of the surface-treated filler other than the surface-treated filler (B), and the volume of other fillers. The volume of the surface-treated filler (B) represents the volume of the filler before the filler is surface-treated, and the volume of the polymer component is the total of the volume of the polymer component (A) and the volume of the surface treatment agent used for the surface treatment of the filler.

$$Filler content ( \% by volume ) = \frac{Volume ( {cm}^{3} ) of filler}{\begin{matrix}Volume ( {cm}^{3} ) of polymer component + \\ volume ( {cm}^{3} ) of filler\end{matrix}} \times 100 \qquad ( iv )$$

$$Filler volume ( {cm}^{3} ) = \frac{Amount ( g ) of filler}{Specific gravity ( g / {cm}^{3} ) of filler} \\ \begin{matrix}Polymer \\ volume ( {cm}^{3} )\end{matrix} = \frac{\begin{matrix}Amount ( g ) of \\ polymer component\end{matrix}}{\begin{matrix}Specific gravity \\ ( g / {cm}^{3} ) of \\ polymer component\end{matrix}} + \frac{\begin{matrix}Amount ( g ) of \\ surface \\ treatment agent\end{matrix}}{\begin{matrix}Specific gravity \\ ( g / {cm}^{3} ) of surface \\ treatment agent\end{matrix}}$$

### (2) Viscosity

Viscosity was measured in accordance with JIS K7210:2014 using a flow viscometer (GFT-100EX, manufactured by Shimadzu Corporation) at a temperature of 30° C., a die hole size (diameter) of 1.0 mm, and a test force of 10 (weight 1.8 kg).

### (3) Hardness (Shore 00 Hardness)

The obtained sheet having a thickness of 2.0 mm was cut into strips of 20 mm in width and 30 mm in length. Two blocks made by stacking three strips on top of each other were used as a measurement sample. Using an Asker A hardness tester (Asker C rubber hardness tester, manufactured by Kobunshi Keiki Co., Ltd.), the Shore 00 hardness of the measurement sample was measured according to ASTM D2240 hardness test (Shore 00).

### (4) Hardness (A Hardness)

The obtained sheet having a thickness of 6 mm and $45 mm was cut to produce a measurement sample. Using a rubber hardness tester (Asker C rubber hardness tester, manufactured by Kobunshi Keiki Co., Ltd.), the A hardness of the measurement sample was measured according to JIS K7312: 1996.

### (5) Thermal Conductivity

The obtained sheet having a thickness of 2.0 mm was cut into strips with a width of 20 mm and a length of 30 mm. Two blocks made by stacking three strips on top of each other were prepared, and the surface of the blocks was covered with wrap to produce two measurement samples. The thermal conductivity was measured by setting the probe of a hot disk method measuring device (manufactured by Kyoto Electronics Industry Co., Ltd., TPS-2500) conforming to ISO 22007-2:2008 in such a way that the probe was sandwiched between the measurement samples from above and below.

TABLE 2

| | | Example | Example | Example | Comparative | Comparative | Comparative |
|---|---|---|---|---|---|---|---|
| | | 1 | 2 | 3 | Example 1 | Example 2 | Example 3 |
| Polymer component (A) | DOWSIL ™ | 75.0 | 93.5 | 66.3 | 100.0 | 97.0 | 109.5 |
| (parts by mass) | CY52-276 | | | | | | |
| Surface treatment filler | Surface- | 900.0 | — | — | — | — | — |
| (B) (parts by mass) | treated filler | | | | | | |
| | (B1) | | | | | | |
| | Surface- | — | 900.0 | — | — | — | — |
| | treated filler | | | | | | |
| | (B2) | | | | | | |
| | Surface- | — | — | 900.0 | — | — | — |
| | treated filler | | | | | | |
| | (B3) | | | | | | |
| Surface treatment filler | Surface- | — | — | — | 900.0 | — | — |
| (parts by mass) other | treated filler | | | | | | |
| than surface treatment | (b1) | | | | | | |
| filler (B) | Surface- | — | — | — | — | 900.0 | — |
| | treated filler | | | | | | |
| | (b2) | | | | | | |
| Other fillers (parts by | AES-12/ | — | — | — | — | — | 900.0 |
| mass) | BAK-5 = 4/5 | | | | | | |
| | (mass ratio) | | | | | | |
| | (no surface | | | | | | |
| | treatment) | | | | | | |
| Silicon-containing | Silicon- | 772.4 | 786.9 | 763.6 | 792.6 | 790.2 | 800.0 |
| oxide-coated nitride (C) | containing | | | | | | |
| (parts by mass) | oxide-coated | | | | | | |
| | aluminum | | | | | | |
| | nitride (C1) | | | | | | |

| | | | | | | |
|---|---|---|---|---|---|---|
| Content (% by volume) of filler | 80.7 | 80.7 | 80.7 | 80.7 | 80.7 | 80.7 |
| contained in composition | | | | | | |
| Content (% by mass) of polymer | 4.3 | 5.3 | 3.8 | 5.6 | 5.4 | 6.1 |
| component (A) contained in composition | | | | | | |
| Content (% by mass) of surface | 51.5 | 50.6 | 52.0 | 0.0 | 0.0 | 0.0 |
| treatment filler (B) contained in | | | | | | |
| composition | | | | | | |
| Content (% by mass) of silicon- | 44.2 | 44.2 | 44.1 | 44.2 | 44.2 | 44.2 |
| containing oxide-coated nitride (C) | | | | | | |
| contained in composition | | | | | | |
| Viscosity (Pa · s) | 233 | 302 | 267 | 710 | 420 | —*¹ |
| Hardness (Shore 00) | 27 | 28 | 25 | 83 | 92 | —*¹ |
| Thermal conductivity (W/m · K) | 6.69 | 6.78 | 6.84 | 6.66 | 6.91 | —*¹ |

*¹Measurement not possible because filler could not be filled in polymer component (A).

It can be seen that, as compared with the heat conducting compositions of Comparative Examples 1 and 2, which included a filler surface-treated with a silane coupling agent, the heat conducting compositions of Examples 1 to 3, which include the surface-treated filler (B) and the silicon-containing oxide-coated nitride (C), all had a low viscosity as well as a low hardness that is an appropriate hardness, and that a cured product having a high thermal conductivity could be obtained. From Comparative Example 3, it can be seen that a filler that is not surface treated cannot be filled into the polymer component.

### Example 4

### (Production of Heat Conducting Composition and Sheet)

A polyethylene container was charged with 100.0 parts by mass of silicone rubber (DOWSIL™ EG-3100) as the polymer component (A) and 1621.0 parts by mass of the surface-treated filler (B4) as a surface-treated filler, and the mixture was stirred and mixed with a rotation/revolution mixer (manufactured by THINKY CORPORATION) at a rotation speed of 2000 rpm for 30 seconds. After cooling, the mixture was loosened, 224.0 parts by mass of silicon-containing oxide-coated aluminum nitride (C2) and 1487.0 parts by mass of silicon-containing oxide-coated aluminum nitride (C4) were further added as silicon-containing oxide-coated nitrides, and the mixture was stirred and mixed with the rotation/revolution mixer at a rotation speed of 2000 rpm for 30 seconds to obtain the heat conducting composition of Example 4. In addition, the sheet of Example 4 was obtained in the same manner as in Example 1.

### Examples 5 to 7 and Comparative Example 4: Production of Heat Conducting Composition and Sheet

The heat conducting composition and sheet of each example and comparative example were obtained in the same manner as in Example 4, except that the types and amounts of each component were changed to as shown in Table 3.

Characteristics were measured using the heat conducting composition and the sheet of the heat conducting composition obtained in Example 4 to 7 and Comparative Example 4 under the above-described measurement conditions. The results are shown in Table 3.

TABLE 3

| | | Example | Example | Example | Example | Comparative |
|---|---|---|---|---|---|---|
| | | 4 | 5 | 6 | 7 | Example 4 |
| Polymer component (A) | DOWSIL ™ EG-3100 | 100.0 | 100.0 | 70.0 | 60.0 | 100.0 |
| (parts by mass) | | | | | | |
| Surface treatment filler (B) | Surface-treated filler | 1621.0 | 1700.0 | 1700.0 | 1700.0 | — |
| (parts by mass) | (B4) | | | | | |
| Surface treatment filler | Surface-treated filler | — | — | — | — | 1556.0 |
| (parts by mass) other than | (b3) | | | | | |
| surface treatment filler (B) | | | | | | |
| Silicon-containing oxide- | Silicon-containing | 224.0 | 224.0 | 224.0 | 224.0 | 184.0 |
| coated nitride (C) (parts by | oxide-coated | | | | | |
| mass) | aluminum nitride (C2) | | | | | |
| | Silicon-containing | 1487.0 | 1487.0 | 1487.0 | 1487.0 | 1219.0 |
| | oxide-coated | | | | | |
| | aluminum nitride (C4) | | | | | |

| | | | | | |
|---|---|---|---|---|---|
| Content (% by volume) of filler contained in | 83.6 | 83.6 | 86.0 | 86.8 | 86.8 |
| composition | | | | | |
| Content (% by mass) of polymer component (A) | 2.9 | 2.8 | 2.0 | 1.7 | 3.3 |
| contained in composition | | | | | |
| Content (% by mass) of surface treatment filler (B) | 47.2 | 48.4 | 48.8 | 49.0 | 0.0 |
| contained in composition | | | | | |
| Content (% by mass) of silicon-containing oxide- | 49.9 | 48.7 | 49.2 | 49.3 | 45.9 |
| coated nitride (C) contained in composition | | | | | |
| Viscosity (Pam · s) | 250 | 255 | 700 | 1200 | 3450 |
| Hardness (Shore 00) | 50 | 50 | 55 | 75 | 85 |
| Thermal conductivity (W/m · K) | 10.2 | 10.5 | 11.8 | 12.5 | 12.5 |

It can be seen that, as compared with the heat conducting composition of Comparative Example 4, which included a filler surface-treated with a silane coupling agent, the heat conducting compositions of Examples 4 to 7, which include the surface-treated filler (B) and the silicon-containing oxide-coated nitride (C), all had a low viscosity as well as a low hardness that is an appropriate hardness, and that a cured product having a high thermal conductivity could be obtained.

### Example 8

### (Production of Heat Conducting Composition)

A polyethylene container was charged with 90.0 parts by mass of vinyl group-containing dimethyl silicone rubber (TSE201) as the polymer component (A) and 450.0 parts by mass of the surface-treated filler (B5) as a surface-treated filler, and the mixture was stirred and mixed with a rotation/revolution mixer (manufactured by THINKY CORPORATION) at a rotation speed of 2000 rpm for 30 seconds. After cooling, the mixture was loosened, 386.0 parts by mass of silicon-containing oxide-coated aluminum nitride (C3) as a silicon-containing oxide-coated nitride, 2.0 parts by mass of KN320 as a flame retardant, and 5.0 parts by mass of TC-1 as a vulcanizing agent were further added, and the mixture was stirred and mixed with the rotation/revolution mixer at a rotation speed of 2000 rpm for 30 seconds to obtain the heat conducting composition of Example 8.

### Sheet Production

A mold with a thickness of 6 mm and a hole of $45 mm was placed on a polyester film with a thickness of 0.1 mm that had been subjected to fluorine release treatment, a defoamed heat conducting composition was filled in the hole, covered with a polyester film with a thickness of 0.1 mm to prevent mixing with air, press-molded at a pressure of 0.5 MPa, subjected to primary vulcanization at 120° C. for 30 minutes, further subjected to secondary vulcanization at 200° C. for 4 hours in a hot air circulation oven, and then left to stand at room temperature (23° C.) for one day to obtain a sheet with a thickness of 6.0 mm.

### Example 9 and Comparative Example 5 to 8: Production of Heat Conducting Composition and Sheet

The heat conducting composition and sheet of each example and comparative example were produced in the same manner as in Example 8, except that the types and amounts of each component were changed to as shown in Table 4. In Comparative Examples 7 and 8, the filler could not be filled into the polymer component (A), and a sheet could not be produced.

Characteristics were measured using the heat conducting compositions and the sheets of the heat conducting compositions obtained in Examples 8 and 9 and Comparative Examples 5 and 6 under the above-described measurement conditions. The results are shown in Table 4.

TABLE 4

| | | Example | Example | Comparative | Comparative | Comparative | Comparative |
|---|---|---|---|---|---|---|---|
| | | 8 | 9 | Example 5 | Example 6 | Example 7 | Example 8 |
| Polymer component (A) | TSE201 | 90.0 | 85.5 | 100.0 | 100.0 | 109.0 | 113.0 |
| (parts by mass) | | | | | | | |
| Surface treatment filler | Surface- | 450.0 | 675.0 | — | — | — | — |
| (B) (parts by mass) | treated | | | | | | |
| | filler (B5) | | | | | | |
| Surface treatment filler | Surface- | — | — | 450.0 | 675.0 | — | — |
| (parts by mass) other | treated | | | | | | |
| than surface treatment | filler (b4) | | | | | | |
| filler (B) | | | | | | | |
| Other fillers (parts by | AKP30/ | — | — | — | — | 450.0 | 675.0 |
| mass) | AA-3 = 4/5 | | | | | | |
| | (mass | | | | | | |
| | ratio) (no | | | | | | |
| | surface | | | | | | |
| | treatment) | | | | | | |
| Silicon-containing oxide- | Silicon- | 386.0 | 578.0 | 394.0 | 591.0 | 400.0 | 650.0 |
| coated nitride (C) (parts | containing | | | | | | |
| by mass) | oxide- | | | | | | |
| | coated | | | | | | |
| | aluminum | | | | | | |
| | nitride | | | | | | |
| | (C3) | | | | | | |
| Additive (parts by mass) | KN320 | 2.0 | 2.0 | 2.0 | 2.0 | 2.0 | 2.0 |
| Vulcanizing agent (parts | TC-1 | 5.0 | 5.0 | 5.0 | 5.0 | 5.0 | 5.0 |
| by mass) | | | | | | | |

| | | | | | | |
|---|---|---|---|---|---|---|
| Content (% by volume) of filler | 67.6 | 75.2 | 67.6 | 75.2 | 67.6 | 75.2 |
| contained in composition | | | | | | |
| Content (% by mass) of polymer | 9.6 | 6.4 | 10.5 | 7.3 | 11.3 | 7.8 |
| component (A) contained in | | | | | | |
| composition | | | | | | |
| Content (% by mass) of surface | 48.2 | 50.2 | 0.0 | 0.0 | 0.0 | 0.0 |
| treatment filler (B) contained in | | | | | | |
| composition | | | | | | |
| Content (% by mass) of silicon- | 41.4 | 43.0 | 41.4 | 43.0 | 41.4 | 45.0 |
| containing oxide-coated nitride (C) | | | | | | |
| contained in composition | | | | | | |
| Viscosity (Pa · s) | 120 | 1200 | 200 | 3200 | —*² | —*² |
| Hardness (A hardness) | 80 | 89 | 92 | 96 | —*² | —*² |
| Thermal conductivity (W/m · K) | 3.25 | 5.91 | 3.27 | 5.90 | —*² | —*² |

*²Measurement not possible because filler could not be filled in polymer component (A).

A comparison of the Examples that had the same filler content (% by volume) and included the surface-treated filler (B) and the silicon-containing oxide-coated nitride (C) with the Comparative Examples including a filler that had been surface treated by a silane coupling agent, the heat conducting compositions of the Examples had a lower viscosity as well as a lower hardness that was an appropriate hardness, and that a cured product having a higher thermal conductivity could be obtained (see Example 8 and Comparative Example 5, and Example 9 and Comparative Example 6). Further, it can be seen that a filler that is not surface treated cannot be filled into the polymer component (see Comparative Examples 7 and 8).

1. A heat conducting composition comprising:
a polymer component (A);
a surface-treated filler (B) obtained by surface-treating a filler with α-butyl-ω-(2-trimethoxysilylethyl)polydimethylsiloxane having a weight average molecular weight of 500 to 5,000, with the α-butyl-ω-(2-trimethoxysilylethyl)polydimethylsiloxane having an adhesion percentage to the filler of from 20.0 to 50.0% by mass; and
a silicon-containing oxide-coated nitride (C) having a nitride and a silicon-containing oxide coating that coats the nitride.

2. The heat conducting composition according to claim 1, wherein the nitride is aluminum nitride.

3. The heat conducting composition according to claim 1, wherein the filler has a cumulative volume-based 50% particle size of from 0.1 to 30 μm, and the nitride has a cumulative volume-based 50% particle size of from 10 to 150 μm.

4. The heat conducting composition according to claim 1, wherein the filler is at least one selected from the group consisting of a metal, silicon, a metal oxide, a nitride, and a composite oxide.

5. The heat conducting composition according to claim 1, wherein the polymer component (A) is at least one selected from the group consisting of a thermosetting resin, an elastomer, and an oil.

6. The heat conducting composition according to claim 1, wherein the polymer component (A) has a viscosity at 25° C. of from 30 to 4,000,000 mPa·s.

7. The heat conducting composition according to claim 1, wherein the polymer component (A) has a content of from 1.0 to 15.0% by mass, the surface-treated filler (B) has a content of from 30.0 to 96.0% by mass, and the silicon-containing oxide-coated nitride (C) has a content of from 3.0 to 55.0% by mass based on the total amount of the heat conducting composition.

8. A cured product of the heat conducting composition according to claim 1.

9. The cured product of the heat conducting composition according to claim 8, wherein the cured product has a thermal conductivity of 3.0 W/m·K or more.
